(19) United States
(12) Patent Application Publication
(10) Pub. No.: US 2026/0155292 A1
(43) Pub. Date: Jun. 4, 2026

(54) INDUCTOR AND METHOD FOR MANUFACTURING INDUCTOR

(71) Applicant: Murata Manufacturing Co., Ltd., Kyoto-fu (JP)

(72) Inventor: Kazuhiro NAKAMURA, Nagaokakyo-shi (JP)

(73) Assignee: Murata Manufacturing Co., Ltd., Kyoto-fu (JP)

(21) Appl. No.: 19/456,210

(22) Filed: Jan. 22, 2026

Related U.S. Application Data
(63) Continuation of application No. PCT/JP2024/037430, filed on Oct. 21, 2024.

(30) Foreign Application Priority Data
Jan. 11, 2024 (JP) 2024-002403

(51) Int. Cl. H01F 27/255; H01F 41/02

(52) U.S. Cl. CPC H01F 27/255; H01F 41/0246

(57) ABSTRACT

An inductor having improved magnetic characteristics and a method for manufacturing the inductor. An inductor includes an element body including a plurality of magnetic metal powder particles and a coil in the element body. Each magnetic metal powder particle includes a magnetic metal core particle containing Fe and an oxide layer containing a readily oxidizable material having a higher tendency to oxidation than Fe. When an interparticle layer region is defined as a region where a distance between the surface of a first magnetic metal core particle and the surface of a second magnetic metal core particle adjacent to the first magnetic metal core particle is smaller, and a non-interparticle layer region is defined as a region where the distance is larger, the concentration of the readily oxidizable material in the non-interparticle layer region is higher than that in the interparticle layer region.

### CROSS-REFERENCE TO RELATED APPLICATIONS

This application claims benefit of priority to International Patent Application No. PCT/JP2024/037430, filed Oct. 21, 2024, and to Japanese Patent Application No. 2024-002403, filed Jan. 11, 2024, the entire contents of each are incorporated herein by reference.

### BACKGROUND

### Technical Field

The present disclosure relates to an inductor and a method for manufacturing the inductor.

### Background Art

Japanese Unexamined Patent Application Publication No. 2012-164958 discloses a type of coil component in which a helical coil is covered by a magnetic body and in direct contact with the magnetic body, wherein the magnetic body is mainly composed of magnetic alloy particles and contains no glass components, and each magnetic alloy particle has on its surface an oxide layer of the magnetic alloy particle. It is also disclosed that the oxide layer at least contains Fe₃O₄, which is a magnetic substance, and Fe₂O₃ and Cr₂O₃, which are non-magnetic substances.

### SUMMARY

The coil component described in Japanese Unexamined Patent Application Publication No. 2012-164958 contains Cr, which is a non-magnetic component, in the oxide layers between the magnetic alloy particles and thus needs to be further improved in magnetic characteristics. More specifically, new findings have revealed that improving the concentration profile of non-magnetic components in the oxide layer leads to better magnetic characteristics of inductors.

Therefore, the present disclosure provides an inductor having improved magnetic characteristics and a method for manufacturing the inductor.

An inductor according to the present disclosure includes an element body including a plurality of magnetic metal powder particles; and a coil provided in the element body. Each magnetic metal powder particle includes a magnetic metal core particle containing Fe and an oxide layer containing a readily oxidizable material having a higher tendency to oxidation than Fe. Also, wherein when an interparticle layer region is defined as a region where a distance between a surface of a first magnetic metal core particle and a surface of a second magnetic metal core particle adjacent to the first magnetic metal core particle is smaller, and a non-interparticle layer region is defined as a region where the distance is larger, a concentration of the readily oxidizable material in the non-interparticle layer region is higher than a concentration of the readily oxidizable material in the interparticle layer region.

A method for manufacturing an inductor according to the present disclosure is a method for manufacturing the inductor described above and includes a preparation step of adding the readily oxidizable material to the magnetic metal core particles to prepare a magnetic material for forming an element body; a pressurization step of pressurizing an element body precursor formed of the magnetic material to distribute a greater amount of the readily oxidizable material in the non-interparticle layer region than in the interparticle layer region; and a heat treatment step of heating the magnetic material to form an oxide layer on a surface of each magnetic metal core particle, the oxide layer containing the readily oxidizable material.

According to the present disclosure, an inductor having improved magnetic characteristics and a method for manufacturing the inductor can be provided.

### BRIEF DESCRIPTION OF THE DRAWINGS

FIG. 1 is a perspective view of an inductor according to the present disclosure;

FIG. 2 is an exploded perspective view of one embodiment of the inductor according to the present disclosure;

FIG. 3 is a cross-sectional view showing one field of view of the central area of a cut surface of an element body in FIG. 1 obtained by cutting the element body perpendicular to the mounting surface and end surfaces of the element body through the central part of the element body and the winding axis of a coil;

FIG. 4 is an enlarged cross-sectional view corresponding to the area surrounded by the dashed line in FIG. 3;

FIG. 5A is a graph showing the concentration distribution of Si, Fe, and Zn in an interparticle layer region;

FIG. 5B is a graph showing the concentration distribution of Si, Fe, and Zn in a non-interparticle layer region;

FIG. 5C is a graph showing the concentration distribution of Si, Fe, and Zn at another position in the non-interparticle layer region;

FIG. 6 is a manufacturing flow illustrating a process of manufacturing the inductor according to the present disclosure;

FIG. 7 is an elemental mapping image of an inductor of Comparative Example;

FIG. 8 is an elemental mapping image of an inductor of Example;

FIG. 9 is a graph showing the permeability change before and after heat treatment

FIG. 10 is a table showing the permeability change in Comparative Example and Examples 1 to 4, serving as a basis for the graph in FIG. 9.

### DETAILED DESCRIPTION

Hereinafter, an inductor according to the present disclosure will be described. Note that the present disclosure is not limited to the following configurations and may be modified as appropriate without departing from the spirit and scope of the present disclosure. The present disclosure also encompasses combinations of individual preferable configurations described below.

The inductor according to the present disclosure is used, for example, for DC-DC converters. The inductor according to the present disclosure can also be used for applications other than DC-DC converters.

As used herein, terms indicating the relationships between elements (e.g., “parallel”, “perpendicular”, and the like) and terms indicating the shapes of elements mean not only literal and strict interpretations of the terms, but also scopes and ranges substantially equivalent to the terms, for example, ranges including a margin of error of about a few percent. In the present description, the direction in which magnetic layers and coil conductors for forming an element body are stacked is referred to as a “stacking direction”.

In the explanation in the present description, references to directions, orientations, or the like are merely for the convenience of illustration and are not intended to limit the scope of the present disclosure unless explicitly stated otherwise. For example, relative terms such as “out (or outside, outer, or outer peripheral)” and “in (or inside, inner, or inner peripheral)”, derivatives thereof, and the like are to be understood as referring to the directions as described or illustrated. That is, the present disclosure need not be limited to a specific direction, orientation, form, or the like unless explicitly stated otherwise. The same applies to terms such as “provided” and “connected” as well as derivatives thereof; these terms may refer not only to direct modes, but also to modes involving other elements such as intervening elements unless explicitly stated otherwise.

The drawings shown below are schematic representations, and the dimensions, scales of aspect ratios, and the like may differ from those of an actual product.

### Inductor According to the Present Disclosure

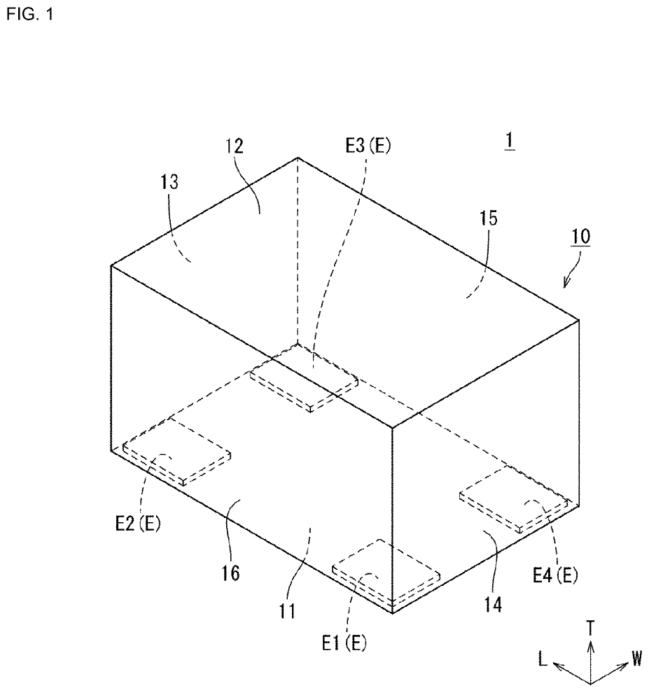

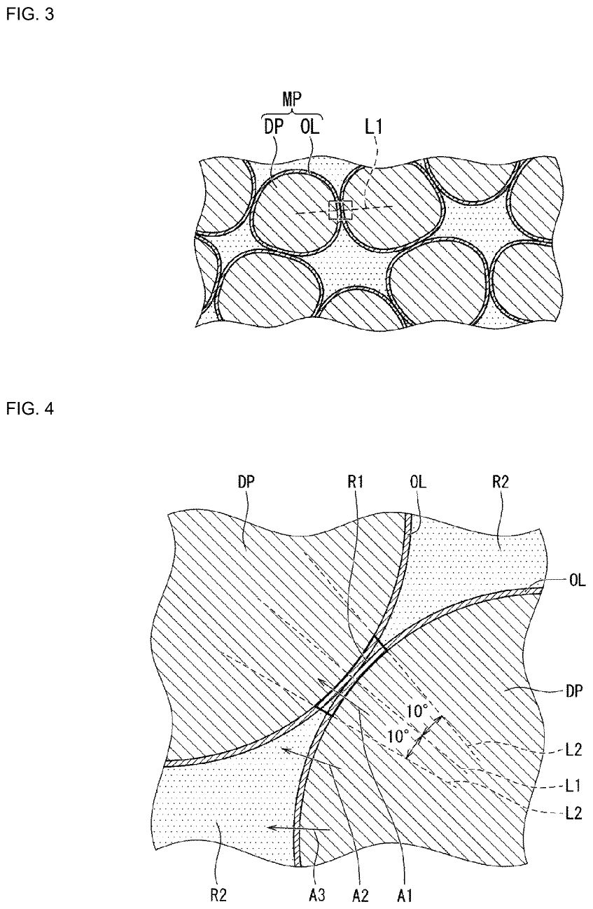

Hereinafter, the inductor according to the present disclosure will be described with reference to FIGS. 1 to 5C. The inductor according to the present disclosure includes an element body 10 including a plurality of magnetic metal powder particles MP (see FIG. 3) and a coil provided in the element body 10.

The element body 10 has, for example, a cuboidal or substantially cuboidal shape having six faces (see FIG. 1). The element body 10 may have rounded corners and ridges. Each corner is a point where three faces of the element body 10 meet, and each ridge is a point where two faces of the element body 10 meet.

The length, width, and height directions of the inductor 1 and the element body 10 are indicated by directions L, W, and T, respectively, in FIG. 1. The length direction L, the width direction W, and the height direction T are perpendicular to each other. The inductor 1 has a mounting surface, which is, for example, a face parallel to the length direction L and the width direction W (LW face).

The element body 10 shown in FIG. 1 has a first main surface 11 and a second main surface 12 facing each other in the height direction T, a first end surface 13 and a second end surface 14 facing each other in the length direction L perpendicular to the height direction T, and a first side surface 15 and a second side surface 16 facing each other in the width direction W perpendicular to both the length direction L and the height direction T. In the example shown in FIG. 1, the first main surface 11 of the element body 10 corresponds to the mounting surface (bottom surface) of the element body 10. The second main surface 12 may be the mounting surface of the element body 10.

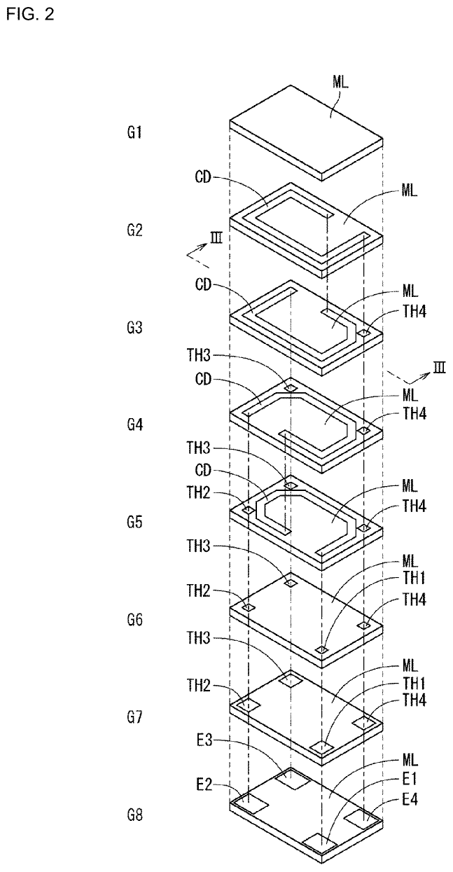

The element body 10 has a multilayer structure in which a plurality of element body layers including magnetic layers ML and coil conductors CD (see FIG. 2) are stacked in a stacking direction (e.g., the height direction T). In the present embodiment, the element body 10 is formed by stacking element body layers G1 to G8 as shown in FIG. 2. The coil is formed by stacking a plurality of coil conductors CD. The coil formed of the stacked coil conductors CD is more compact than wire-wound coils formed by winding conductive wires. The boundaries between the respective layers of the multilayer structure in the element body 10 have disappeared. Each of the stacked element body layers G1 to G8 may have the same pattern.

The element body 10 includes a coil formed by stacking a plurality of coil conductors CD. In the example shown in FIG. 2, the element body 10 includes two coils (a first coil and a second coil) disposed along the stacking direction. More specifically, the first coil is formed of the coil conductors CD in the element body layers G4 and G5, and the second coil is formed of the coil conductors CD in the element body layers G2 and G3. The inductor 1 of a first embodiment is not limited to this example, and for example, may include three or more coils disposed along the stacking direction. Alternatively, the element body 10 may include a coil array including a plurality of coils arranged in parallel in a direction intersecting the stacking direction (the direction L in FIG. 1).

The element body 10 has outer electrodes E on the mounting surface (first main surface 11) of the element body 10. In the example shown in FIG. 2, the outer electrodes E include a first outer electrode E1 and a second outer electrode E2 connected to the respective end portions of the first coil, and a third outer electrode E3 and a fourth outer electrode E4 connected to the respective end portions of the second coil. The number of outer electrodes is two per coil. This means that when the number of coils is three, the number of outer electrodes may be six.

The coils (coil conductors CD) and the outer electrodes E are connected via through-hole conductors TH. That is, the through-hole conductors TH include a first through-hole conductor TH1 to a fourth through-hole conductor TH4 corresponding to the first outer electrode E1 to the fourth outer electrode E4. The first through-hole conductor TH1 to the fourth through-hole conductor TH4 extend along the stacking direction.

Each magnetic layer ML in the element body layers G1 to G8 includes magnetic metal powder particles MP (see FIG. 3) formed of a magnetic material. Each magnetic metal powder particle MP includes a magnetic metal core particle DP, an oxide layer OL, and a resin.

The average particle size of the magnetic metal powder particles MP may be preferably 0.2 μm to 20 μm, more preferably 0.2 μm to 15 μm, and still more preferably 1 μm to 6 μm.

The average particle size of the magnetic metal powder particles MP can be measured using the following procedure. An inductor sample is cut to obtain a cross-section of the sample. Specifically, the sample is cut perpendicular to the mounting surface and end surfaces of the element body through the central part of the element body and the winding axis of the coil to obtain a cross-section of the sample. The cross-section of the sample may be flattened using ion milling or another method. The cross-section is subjected to SEM imaging (at about 1,000-fold magnification) and EDX compositional analysis at any three sites in the central area of the cut surface corresponding to the central part of the element body 10. The results of the EDX compositional analysis allow the location of Fe to be identified in the imaging field of view, thus enabling the locations of magnetic metal powder particles MP to be identified in the SEM image. The average value of the equivalent circular diameter of the identified magnetic metal powder particles MP is regarded as the average particle size of the magnetic metal core particles. The “average particle size” as used herein may refer to the average particle size D50 (particle size at a cumulative volume percentage of 50%).

The magnetic metal core particle DP contains at least Fe (iron). More specifically, the magnetic metal core particle DP may be a particle or an alloy particle each containing Fe and Si. Examples of the magnetic metal core particle DP include Fe—Si alloy, Fe—Si—Cr (chromium) alloy, Fe—Si—Al (aluminum) alloy, Fe—Si—B (boron)-P (phosphorus)-Cu (copper)-C (carbon) alloy, and Fe—Si—B—Nb (niobium)-Cu alloy. The magnetic metal core particle DP may also contain unintended impurities resulting from the manufacturing process, such as Cr, Mn (manganese), Cu, Ni (nickel), P, S (sulfur), and Co (cobalt). The magnetic metal core particle DP may be contained in a magnetic paste, as will be detailed in the section describing the manufacturing method. The magnetic paste may contain a readily oxidizable material having a higher tendency to oxidation than Fe (e.g., Zn (zinc), Zr (zirconium), Al (aluminum), Ti (titanium), Mg (magnesium), Cr (chromium), or Mo (molybdenum)). The readily oxidizable material contained in the magnetic paste is allowed to surround the surface of each magnetic metal core particle DP, and the readily oxidizable material on the surface of each magnetic metal core particle DP is preferentially oxidized. The oxide of the readily oxidizable material remains on the surface of each magnetic metal core particle DP, resulting in a reduction in the oxidation of the element Fe contained in the magnetic metal core particles. This reduces a decrease in permeability caused by oxidation of the element Fe and achieves higher permeability of the inductor 1. The resin component of the magnetic paste may be eliminated by heat treatment of the element body or may remain after heat treatment. The material selected as the readily oxidizable material having a higher tendency to oxidation than Fe is different from the constituents of the magnetic metal core particle DP. For example, when the magnetic metal core particle DP is formed of an Fe—Si—Cr alloy, the readily oxidizable material is selected from materials other than Si and Cr.

The surface of the magnetic metal core particle DP is covered with an insulation layer. The “insulation properties” as used herein are intended to refer to a volume resistivity of 1 MΩcm or more. The insulation layer covering the surface of each magnetic metal core particle DP can provide higher insulation between the magnetic metal core particles DP. A specific example of the insulation layer is an oxide layer OL as shown in FIG. 3. An insulating material may be provided outside the oxide layer OL, that is, an insulating material which is not shown in the figure may cover the magnetic metal core particle DP and the oxide layer OL.

The oxide layer OL is formed by oxidation of an element having a higher tendency to oxidation than Fe contained in the magnetic metal core particle DP. That is, the oxide layer OL may contain an oxide of the above-mentioned readily oxidizable material having a higher tendency to oxidation than Fe, and an oxide of a material from the magnetic metal core particle DP. The “readily oxidizable material having a higher tendency to oxidation than Fe” as used herein is intended to refer to a material having a higher ionization tendency than Fe. The thickness of the oxide layer OL may be preferably 1 nm to 100 nm, more preferably 1 nm to 50 nm, and still more preferably 1 nm to 20 nm. The thickness of the oxide layer OL can be measured, for example, as follows: a polished cross-section of an inductor sample is imaged with a scanning electron microscope (SEM) or transmission electron microscope (TEM), and the SEM images are used to measure the thickness of the oxide layer OL covering the surface of the magnetic metal core particle DP. Specifically, the inductor sample is cut perpendicular to the mounting surface and end surfaces of the element body through the central part of the element body and the winding axis of the coil to obtain a cut surface, and images are taken at any three sites in the central area of the cut surface for the measurement of the thickness of the oxide layer OL. Then, the thickness of the oxide layer OL is measured at any three sites in the central area of each field of view. The average of the measurements at nine sites (any three sites in the central area of the cut surface)×(any three sites in the central area of each field of view) may be regarded as the thickness of the oxide layer OL.

As a suitable readily oxidizable material, the oxide layer may contain at least one selected from the group consisting of Zr, Al, Ti, Mg, Cr, and Mo. More specifically, metals having a higher ionization tendency than Fe may be used. Such readily oxidizable materials are preferentially oxidized over the magnetic metal powder particles and thus contribute to a reduction in the oxidation of Fe-containing magnetic metal core particles DP.

For enhancing the strength of the element body 10, resin impregnation may be performed on the heat-treated element body 10 formed of the stacked element body layers G1 to G8 so as to distribute a resin between adjacent magnetic metal powder particles MP coupled via the insulation layers. The resin used for the resin impregnation of the heat-treated element body 10 may be, for example, one or more resins selected from the group consisting of epoxy resin, phenolic resin, polyester resin, polyimide resin, polyolefin resin, silicone resin, acrylic resin, polyvinyl butyral resin, cellulose resin, alkyd resin, and other resins.

When the inductor 1 according to the present embodiment is cut perpendicular to the mounting surface and end surfaces of the element body through the central part of the element body and the winding axis of the coil to obtain a cut surface and images are taken at any three sites in the central area of the cut surface, it can be found in each field of view that the element body contains the resin and voids in the regions surrounding a plurality of magnetic metal powder particles MP and represented with dots in FIG. 3. Here, image analysis software (e.g., image analysis software WinROOF 2021 (manufactured by Mitani Corporation)) is used to select, from among the plurality of magnetic metal powder particles MP, one magnetic metal core particle DP and another magnetic metal core particle DP adjacent to the one magnetic metal core particle DP on the basis of the criterion that the distance between the centers of gravity of the two magnetic metal core particles DP is 100 nm or less. As shown in FIG. 4, under the observation of the area between the one magnetic metal core particle DP and the other magnetic metal core particle DP, when an interparticle layer region R1 is defined as a region where the distance between the surface of the one magnetic metal core particle DP and the surface of the other magnetic metal core particle DP adjacent to the one magnetic metal core particle DP is smaller, and a non-interparticle layer region R2 is defined as a region where the distance between the surface of the one magnetic metal core particle DP and the surface of the other magnetic metal core particle DP adjacent to the one magnetic metal core particle DP is larger, the concentration of the readily oxidizable material in the non-interparticle layer region R2 is higher than that in the interparticle layer region R1. The “interparticle layer region” as used herein is intended to refer to a region lying between two opposing particles and flanked by two imaginary lines L2 as shown in FIG. 4, in which an imaginary line L1 is a line connecting the centers of gravity of adjacent particles, and the imaginary lines L2 extend from the center of gravity of one magnetic metal core particle on both sides of the imaginary line L1 at angles of ±10°. The maximum distance between the two particles in FIG. 4 is, for example, 50 nm or less. These imaginary lines L1 and L2 can be drawn using image analysis software (e.g., image analysis software WinROOF 2021 (manufactured by Mitani Corporation)) at the time of determining the equivalent circular diameter of the magnetic metal powder particles MP as described above. The “non-interparticle layer region” as used herein is intended to refer to a region other than the interparticle layer region, specifically a region where the particle-to-particle distance is larger than that in the interparticle layer region.

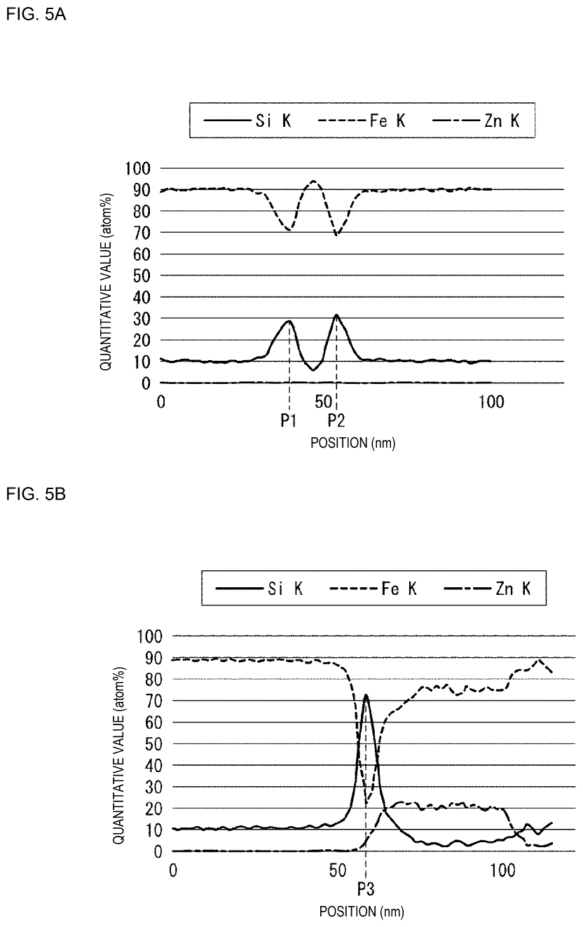

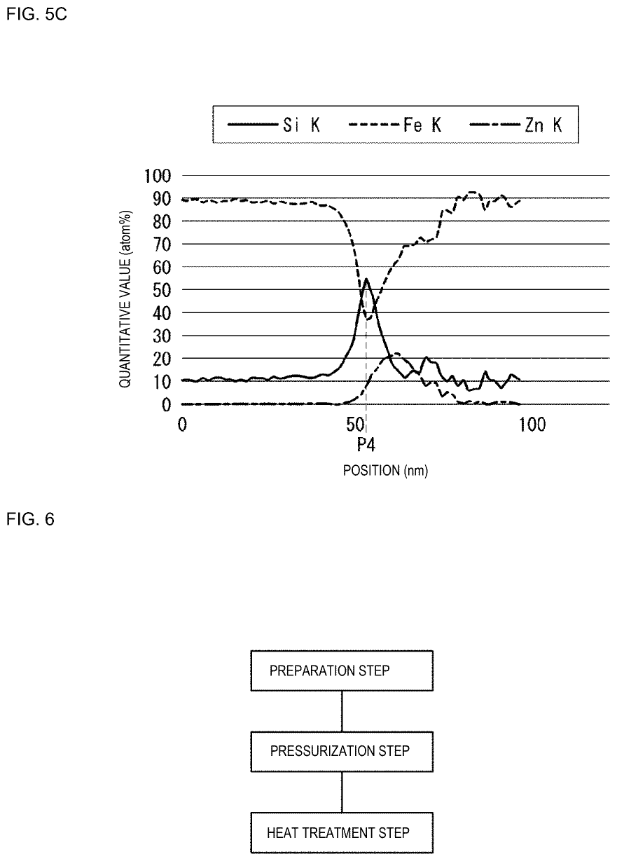

The “concentration of the readily oxidizable material” as used herein can be measured using the procedure described below. The inductor is cut from the mounting surface (first main surface 11) of the element body 10 in the depth direction of the element body 10 along the length of the element body 10 through the winding axis of the coil to create a cut surface. The cut surface is subjected to TEM imaging (at about 600,000-fold magnification) to capture an image of an area around the winding axis of the coil such that the magnetic metal powder particles MP are in the field of view, and the locations of the magnetic metal powder particles MP are identified. Then, the identified locations are subjected to quantitative analysis using EDX. In the quantitative analysis using EDX, compositional analysis is performed by line scanning across the edges of the magnetic metal core particles DP, and the obtained compositional analysis graph is used to measure the maximum concentration value of the readily oxidizable material. The “concentration of the readily oxidizable material in the interparticle layer region” is defined as the average of the maximum concentration values measured at the imaginary line L1 and two sites inside the imaginary lines L2 and equidistant from the imaginary line L1. The “concentration of the readily oxidizable material in the non-interparticle layer region” is defined as the average of the maximum concentration values measured at a site outside one of the imaginary lines L2 and a site outside the other imaginary line L2, the two sites being equidistant from the respective imaginary lines L2. Although the details of the analysis will be detailed later in the “EXAMPLES” section, the line scanning results for the interparticle layer region R1 are as shown in FIG. 5A, and the line scanning results for the non-interparticle layer region R2 are as shown in FIGS. 5B and 5C. Note that the “concentration of the readily oxidizable material” as used herein excludes O (oxygen), C (carbon), and other impurities.

The line scanning results show that the concentration of the readily oxidizable material in the non-interparticle layer region R2 (the maximum value of the Zn concentration in FIG. 5B or FIG. 5C) is higher than that in the interparticle layer region R1 (the maximum value of the Zn concentration in FIG. 5A). These line scanning results may be partly because the magnetic material is pressurized during the pressurization step of the “method for manufacturing inductor” described later to force the readily oxidizable material in the interparticle layer region R1 toward the non-interparticle layer region R2, resulting in the concentration of the readily oxidizable material as described above.

In the inductor 1 according to the present embodiment, the concentration of the readily oxidizable material in the non-interparticle layer region R2 is higher than that in the interparticle layer region R1. As a result, in the non-interparticle layer region R2, the readily oxidizable material having a higher tendency to oxidation than Fe is preferentially oxidized over Fe, thus contributing to a reduction in Fe oxidation. In the interparticle layer region R1, the readily oxidizable material is present at a lower concentration, and a reduced amount of the non-magnetic component contributes to an improvement in magnetic characteristics.

A suitable interparticle layer region may be one in which the distance between one magnetic metal core particle DP and the other magnetic metal core particle DP adjacent to the one magnetic metal core particle DP is at least 20 nm to 100 nm. When the distance between the magnetic metal core particles DP is 20 nm to 100 nm, adequate magnetic characteristics can be retained, and appropriate insulation between the magnetic metal powder particles MP can be provided.

In addition, the oxide layer OL in a suitable non-interparticle layer region R2 may have a surface roughness of 10 nm to 70 nm. The “surface roughness” as used herein is intended to refer to the ten-point average roughness defined in JIS B 0601:1994. The measurement of surface roughness is performed in a region between the two sites where the concentration of the readily oxidizable material in the non-interparticle layer region R2 has been measured, and the ten-point average roughness is calculated. The oxide layer OL having a surface roughness of 10 nm to 70 nm for a magnetic metal powder particle MP of a few micrometer size can adequately cover the magnetic metal core particle DP, thereby enhancing mechanical strength.

Regarding suitable concentrations of the readily oxidizable material according to the present disclosure, the concentration (the maximum concentration value) of the readily oxidizable material in the interparticle layer region R1 may be 0.6 atom % or less, and the concentration (the maximum concentration value) of the readily oxidizable material in the non-interparticle layer region R2 may be 5 atom % to 30 atom %. When the concentrations are at such levels, the interparticle layer region R1 contains the readily oxidizable material at a relatively low concentration ranging 0.6 atom % or less, and a reduced amount of the non-magnetic component contributes to an improvement in magnetic characteristics. In the non-interparticle layer region R2, the readily oxidizable material is present at a relatively high concentration ranging 5 atom % to 30 atom % and thus is preferentially oxidized over Fe, contributing to a reduction in Fe oxidation.

### Method for Manufacturing Inductor According to the Present Disclosure

Hereinafter, a method for manufacturing the inductor according to the present disclosure will be described with reference to FIG. 6. The method for manufacturing the inductor according to the present disclosure includes a preparation step, a pressurization step, and a heat treatment step. The method for manufacturing the inductor may optionally and additionally include a debinding step as described later.

### Preparation Step

First, a magnetic material (magnetic paste) for forming magnetic layers ML of the element body layers G1 to G8 illustrated in FIG. 2 and a conductor paste for forming coil conductors CD are prepared.

In one exemplary method for preparing the magnetic paste, a metal powder, such as Fe—Si alloy or Fe—Si—Cr alloy, having a D50 (particle size at a cumulative volume of 50%) of 2 μm to 20 μm is prepared. The metal powder is mixed with a readily oxidizable material having a higher tendency to oxidation than Fe (e.g., Zn particles: 0.5 wt % or more) as well as a binder such as cellulose or polyvinyl butyral (PVB) and a solvent such as a mixture of terpineol and butyl diglycol acetate (BCA). The mixture is kneaded to prepare a magnetic paste.

When Fe—Si alloy is used as the magnetic metal, the Si content is preferably 2.0 atom % to 8.0 atom %. When Fe—Si—Cr alloy is used as the magnetic metal powder, the Si content is preferably 2.0 atom % to 8.0 atom %. When Fe—Si—Cr alloy is used as the magnetic metal powder, the Cr content is preferably 0.2 atom % to 6.0 atom %.

As the conductor paste, a paste containing Ag as a conductive material is prepared, for example.

The magnetic and conductor pastes described above are used for screen printing or another process to prepare and stack the element body layers G1 to G8 shown in FIG. 2.

### Pressurization Step

After the element body layers G1 to G8 are stacked, the stacked element body layers G1 to G8 are pressurized. Pressurizing the magnetic material and the readily oxidizable material results in a greater amount of the readily oxidizable material being distributed in a non-interparticle layer region R2, where the distance between the magnetic metal core particles is 100 nm or more, than in an interparticle layer region R1, where the distance between the magnetic metal core particles is 100 nm or less. Applying a pressure of 300 MPa or more in this pressurization step achieves a desired concentration of the readily oxidizable material.

In a suitable form of the pressurization step, the pressurization step may be performed with heating at a temperature lower than that in the heat treatment step described later. Specifically, pressurization at a temperature of about 70° C. achieves a desired concentration of the readily oxidizable material.

### Debinding Step (Optional and Additional Step)

A suitable method for manufacturing the inductor may include a debinding step as one of the manufacturing steps. The debinding step is for removing the binder contained in the magnetic and conductive pastes. For example, debinding is performed at a temperature of about 300° C. to about 500° C. This allows the removal of the binder contained in the magnetic and conductive pastes.

### Heat Treatment Step

The debinding step is followed by heat treatment. The temperature for heat treatment is approximately a temperature at which the coil conductors sinter, and for example, may be about 700° C. to about 900° C. In the heat treatment step according to the present disclosure, heat treatment may be performed in an air atmosphere or in a low-oxygen-concentration atmosphere.

Furthermore, to enhance the strength of the element body, the element body may be impregnated with a resin, followed by curing. The resin used for the resin impregnation of the element body is, for example, epoxy resin and may also be one or more resins selected from the group consisting of phenolic resin, polyester resin, polyimide resin, polyolefin resin, silicone resin, acrylic resin, polyvinyl butyral resin, cellulose resin, alkyd resin, and other resins. The series of steps described above leads to the formation of the element body of the inductor according to the present disclosure.

Outer electrodes are then formed on the thus-formed element body such that the outer electrodes are electrically connected to the coil conductors. Specifically, the outer electrodes are formed by electrolytic plating at positions where the through-hole conductors are exposed on the mounting surface (first main surface 11) of the element body 10. The plating material may be Cu. Other examples of the plating material include, but are not limited to, Ni—Sn, Ni—Au, Ni—Cu, and/or Cu—Ni—Au. The formation of the outer electrodes is followed by cutting into individual devices, and thus the inductor of the present embodiment is manufactured.

As described above, the method for manufacturing the inductor described in the present embodiment enables the production of an inductor in which the concentration of the readily oxidizable material in the non-interparticle layer region is higher than that in the interparticle layer region.

### EXAMPLES

Demonstration experiments on soft-magnetic metal powders according to the present disclosure will be detailed. Specifically, inductors described in the following Example and Comparative Example were manufactured.

### Description of Inductor of Example

An Fe—Si alloy metal powder having a D50 (particle size at a cumulative volume of 50%) of 2 μm to 20 μm was prepared, and Zn, serving as a readily oxidizable material having a higher tendency to oxidation than Fe, was added to a magnetic paste. Thus, a magnetic material was prepared. The amount of Zn added was 0.5% relative to the amount of the Fe—Si alloy metal powder.

As described in the preparation step of the method for manufacturing the inductor according to the present disclosure, a conductor paste was also prepared, and the element body layers G1 to G8 shown in FIG. 2 were formed. The element body layers G1 to G8 were stacked to form an element body precursor, which was then pressurized with heating. This was followed by a debinding step and a heat treatment step to manufacture an inductor of Example.

### Description of Inductor of Comparative Example

An inductor of Comparative Example was manufactured in the same manner as the inductor of Example except that the inductor of Comparative Example did not contain Zn as the readily oxidizable material.

### Evaluation of Inductors (Part 1)

The concentration of the readily oxidizable material in each manufactured inductor was evaluated.

First, an interparticle layer region R1 was subjected to compositional analysis using EDX (manufactured by Noran, System 7) by scanning across the edges of the magnetic metal core particles DP. The compositional analysis was performed at nine sites (any three sites in the central area of the cut surface)×(any three sites in the central area of each field of view) as described above. A graph of compositional distribution along a line A1 indicated in FIG. 4 is shown as an example in FIG. 5A. The graph shown in FIG. 5A represents measurement positions of line scanning on the horizontal axis and elemental quantities on the vertical axis. In the graph of FIG. 5A, the positions P1 and P2 of the peak concentrations of Si, which is present in the form of an oxide of the element Si derived from the magnetic metal core particles DP, correspond to positions in the vicinity of the edges of the respective adjacent magnetic metal core particles DP. The region between the positions P1 and P2 of the two peak concentrations of Si corresponds to the interparticle layer region R1. The graph in FIG. 5A shows that the maximum value of the Zn concentration in the interparticle layer region R1 was 0.4 atom %. The maximum value of the readily oxidizable material concentration is defined as the average value of the measurements at the nine sites described above.

Next, a non-interparticle layer region R2 was subjected to compositional analysis using EDX (manufactured by Noran, System 7) by scanning across the edges of the magnetic metal core particles DP. Graphs of compositional distribution along lines A2 and A3 indicated in FIG. 4 are shown as examples in FIGS. 5B and 5C, respectively. The graphs shown in FIGS. 5B and 5C represent measurement positions of line scanning on the horizontal axis and elemental quantities on the vertical axis. In the graphs of FIGS. 5B and 5C, the positions P3 and P4 of the peak concentrations of Si, which is present in the form of an oxide of the element Si derived from the magnetic metal core particles DP, correspond to positions in the vicinity of the edges of the respective magnetic metal core particles DP. The region on the positive side of the position P3 or P4 on the horizontal axis corresponds to the non-interparticle layer region R2. Although FIG. 5B shows partial measurement results, the results of the analysis from one end to the other end of the non-interparticle layer region R2 show that the maximum value of the Zn concentration in the non-interparticle layer region R2 was 22.8 atom %. Similarly, although FIG. 5C shows partial measurement results, the results of the analysis from one end to the other end of the non-interparticle layer region R2 show that the maximum value of the Zn concentration in the non-interparticle layer region R2 was 22.0 atom %.

### Evaluation of Inductors (Part 2)

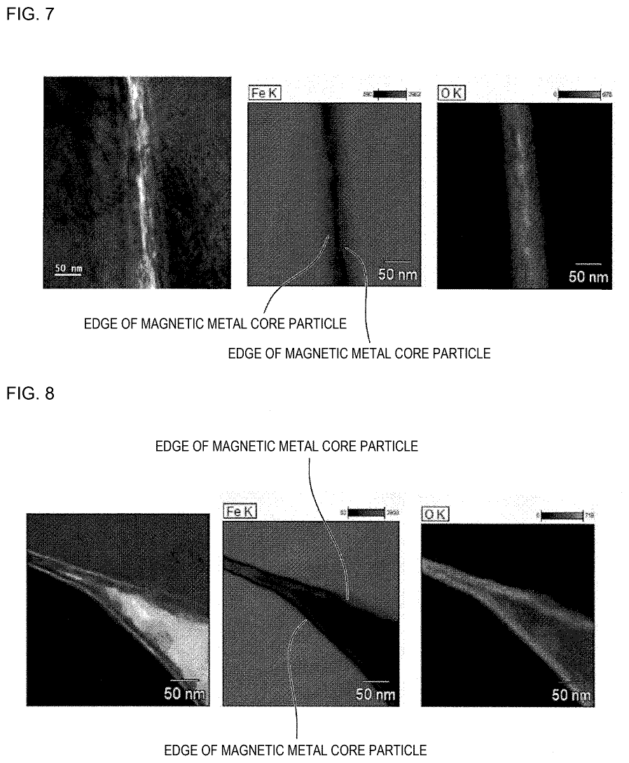

The inductors of Example and Comparative Example were subjected to EDX compositional analysis focused on Fe (iron) and O (oxygen). FIG. 7 shows an SEM image of a measurement site in the inductor of Comparative Example, together with its elemental mapping images for Fe and O. FIG. 8 shows an SEM image of a measurement site in the inductor of Example, together with its elemental mapping images for Fe and O.

In the elemental mapping image for Fe of the inductor of Comparative Example shown in FIG. 7, it can be observed that the component Fe is slightly present in the oxide layer portions outside the edge portions of the respective magnetic metal core particles DP, and O is also present in these oxide layer portions. It can thus be understood that Fe is oxidized in the oxide layer portions. In contrast, in the elemental mapping image for Fe of the inductor of Example shown in FIG. 8, the edge portions of the respective magnetic metal core particles DP are sharply marginated by the presence of the component Fe within these portions as compared with FIG. 7, while almost no component Fe is observed in the oxide layer portions outside the edge portions of the respective magnetic metal core particles DP. It can thus be understood that the oxidation of Fe is reduced as compared with the inductor of Comparative Example.

### Evaluation of Inductors (Part 3)

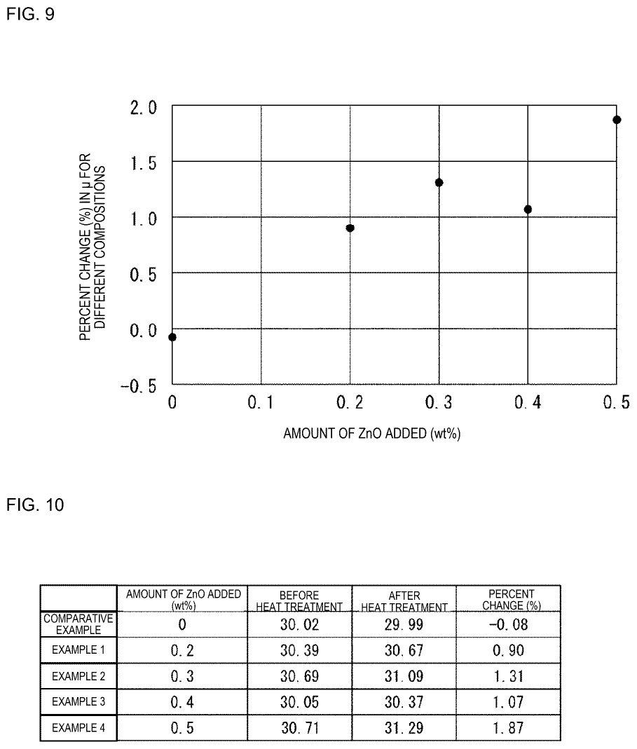

The permeability of the inductors of Comparative Example and Examples was measured for the evaluation of these inductors. The permeability measurement was performed on inductor samples using an impedance analyzer (manufactured by Keysight Technologies, 4991A). As the inductors of Examples, samples were prepared with different amounts of ZnO added, ranging from 0.2 wt % to 0.5 wt %. Specifically, the amount of ZnO added was 0.2 wt % in Example 1, the amount of ZnO added was 0.3 wt % in Example 2, the amount of ZnO added was 0.4 wt % in Example 3, and the amount of ZnO added was 0.5 wt % in Example 4. For the evaluation in this section, the permeability of each inductor before sintering of the coil conductor (before heat treatment) and after sintering of the coil conductor (after heat treatment) was measured, and percent change in permeability was plotted on a graph. The graph of the percent change in permeability is shown in FIG. 9, and the data serving as a basis for this graph is shown in FIG. 10. The impedance analyzer may be any impedance analyzer capable of measuring at 1 MHz. For example, products manufactured by Keysight Technologies such as 4991B, 4990A, and 4294A can be used.

The evaluation results shown in FIGS. 9 and 10 demonstrate that the inductor of Comparative Example showed no change in permeability before and after heat treatment, while the inductors of Examples 1 to 4 showed a significant improvement in permeability before and after heat treatment.

As described above, the results of the evaluation of the inductors confirmed that the maximum value of the Zn concentration in the non-interparticle layer region R2 was higher than that in the interparticle layer region R1. As a result, in the non-interparticle layer region R2, the readily oxidizable material having a higher tendency to oxidation than Fe was preferentially oxidized over Fe, thus resulting in reduced oxidation of Fe as compared with conventional inductors. In the interparticle layer region R1, the readily oxidizable material was present at a lower concentration, and a reduced amount of the non-magnetic component resulted in improved magnetic characteristics as compared with conventional inductors.

The embodiments disclosed herein are to be construed in all respects as illustrative and not restrictive. The technical scope of the present disclosure is not to be construed only from the embodiments described above but is defined on the basis of the recitations in the claims. All changes which come within the meaning and range of equivalency of the claims are intended to be embraced in the technical scope of the present disclosure.

Embodiments of the inductor and the method for manufacturing the inductor according to the present disclosure are as follows.
<1> An inductor including an element body including a plurality of magnetic metal powder particles; and a coil provided in the element body. each magnetic metal powder particle includes a magnetic metal core particle containing Fe and an oxide layer containing a readily oxidizable material having a higher tendency to oxidation than Fe. Also, when an interparticle layer region is defined as a region where a distance between a surface of a first magnetic metal core particle and a surface of a second magnetic metal core particle adjacent to the first magnetic metal core particle is smaller, and a non-interparticle layer region is defined as a region where the distance is larger, a concentration of the readily oxidizable material in the non-interparticle layer region is higher than a concentration of the readily oxidizable material in the interparticle layer region.
<2> The inductor according to <1>, wherein the readily oxidizable material contains at least one selected from the group consisting of Zn, Zr, Al, Ti, Mg, Cr, and Mo.
<3> The inductor according to <1> or <2>, wherein the concentration of the readily oxidizable material in the interparticle layer region is 0.6 atom % or less, and the concentration of the readily oxidizable material in the non-interparticle layer region is 5 atom % to 30 atom %.
<4> The inductor according to any one of <1> to <3>, wherein the distance in the interparticle layer region is 20 nm to 100 nm.
<5> The inductor according to any one of <1> to <4>, wherein the oxide layer in the non-interparticle layer region has a surface roughness of 10 nm to 70 nm.
<6> The inductor according to any one of <1> to <5>, wherein the magnetic metal powder particles have an average particle size of 1 μm to 6 μm.
<7> A method for manufacturing the inductor according to any one of <1> to <6>, the method including a preparation step of adding the readily oxidizable material to the magnetic metal core particles to prepare a magnetic material for forming an element body; a pressurization step of pressurizing an element body precursor formed of the magnetic material to distribute a greater amount of the readily oxidizable material in the non-interparticle layer region than in the interparticle layer region; and a heat treatment step of heating the magnetic material to form an oxide layer on a surface of each magnetic metal core particle, the oxide layer containing the readily oxidizable material.
<8> The method for manufacturing the inductor according to <7>, wherein the pressurization step is performed with heating at a temperature lower than a temperature in the heat treatment step.

The inductor and the method for manufacturing the inductor according to the present disclosure are suitable for use as electronic components having improved magnetic characteristics.

What is claimed is:

1. An inductor comprising:
an element body including a plurality of magnetic metal powder particles; and
a coil in the element body,
wherein
each magnetic metal powder particle includes a magnetic metal core particle including Fe and an oxide layer including a readily oxidizable material having a higher tendency to oxidation than Fe, and
when an interparticle layer region is defined as a region where a distance between a surface of a first magnetic metal core particle and a surface of a second magnetic metal core particle adjacent to the first magnetic metal core particle is smaller, and a non-interparticle layer region is defined as a region where the distance is larger, a concentration of the readily oxidizable material in the non-interparticle layer region is higher than a concentration of the readily oxidizable material in the interparticle layer region.

2. The inductor according to claim 1, wherein
the readily oxidizable material includes at least one selected from the group consisting of Zn, Zr, Al, Ti, Mg, Cr, and Mo.

3. The inductor according to claim 1, wherein
the concentration of the readily oxidizable material in the interparticle layer region is 0.6 atom % or less, and
the concentration of the readily oxidizable material in the non-interparticle layer region is 5 atom % to 30 atom %.

4. The inductor according to claim 1, wherein
the distance in the interparticle layer region is 20 nm to 100 nm.

5. The inductor according to claim 1, wherein
the oxide layer in the non-interparticle layer region has a surface roughness of 10 nm to 70 nm.

6. The inductor according to claim 1, wherein
the magnetic metal powder particles have an average particle size of 1 μm to 6 μm.

7. A method for manufacturing the inductor according to claim 1, the method comprising:
adding the readily oxidizable material to the magnetic metal core particles to prepare a magnetic material for forming an element body;
pressurizing an element body precursor formed of the magnetic material to distribute a greater amount of the readily oxidizable material in the non-interparticle layer region than in the interparticle layer region; and
heating the magnetic material to form an oxide layer on a surface of each magnetic metal core particle, the oxide layer including the readily oxidizable material.

8. The method for manufacturing the inductor according to claim 7, wherein
the pressurizing is performed with heating at a temperature lower than a temperature in the heating.

9. The inductor according to claim 2, wherein
the concentration of the readily oxidizable material in the interparticle layer region is 0.6 atom % or less, and
the concentration of the readily oxidizable material in the non-interparticle layer region is 5 atom % to 30 atom %.

10. The inductor according to claim 2, wherein
the distance in the interparticle layer region is 20 nm to 100 nm.

11. The inductor according to claim 3, wherein
the distance in the interparticle layer region is 20 nm to 100 nm.

12. The inductor according to claim 2, wherein
the oxide layer in the non-interparticle layer region has a surface roughness of 10 nm to 70 nm.

13. The inductor according to claim 3, wherein
the oxide layer in the non-interparticle layer region has a surface roughness of 10 nm to 70 nm.

14. The inductor according to claim 4, wherein
the oxide layer in the non-interparticle layer region has a surface roughness of 10 nm to 70 nm.

15. The inductor according to claim 2, wherein
the magnetic metal powder particles have an average particle size of 1 μm to 6 μm.

16. The inductor according to claim 3, wherein
the magnetic metal powder particles have an average particle size of 1 μm to 6 μm.

17. The inductor according to claim 4, wherein
the magnetic metal powder particles have an average particle size of 1 μm to 6 μm.

18. The inductor according to claim 5, wherein
the magnetic metal powder particles have an average particle size of 1 μm to 6 μm.

19. A method for manufacturing the inductor according to claim 2, the method comprising:
adding the readily oxidizable material to the magnetic metal core particles to prepare a magnetic material for forming an element body;
pressurizing an element body precursor formed of the magnetic material to distribute a greater amount of the readily oxidizable material in the non-interparticle layer region than in the interparticle layer region; and
heating the magnetic material to form an oxide layer on a surface of each magnetic metal core particle, the oxide layer including the readily oxidizable material.

20. A method for manufacturing the inductor according to claim 3, the method comprising:
adding the readily oxidizable material to the magnetic metal core particles to prepare a magnetic material for forming an element body;
pressurizing an element body precursor formed of the magnetic material to distribute a greater amount of the readily oxidizable material in the non-interparticle layer region than in the interparticle layer region; and
heating the magnetic material to form an oxide layer on a surface of each magnetic metal core particle, the oxide layer including the readily oxidizable material.
